(19) United States
(12) Patent Application Publication
(10) Pub. No.: US 2014/0278677 A1
(43) Pub. Date: Sep. 18, 2014

(54) ENHANCED SCHEDULING BASED ON THE AVAILABILTY OF SUB-ENVIRONMENTS IN AN EVENT ENVIRONMENT

(71) Applicant: Microsoft Corporation, Redmond, WA (US)

(72) Inventors: Paul David Tischhauser, Redmond, WA (US); Mark Daniel MacKenzie, Seattle, WA (US); Jason A. Cook, Renton, WA (US); Karl-Erik Bystrom, Bellevue, WA (US); Jasdeep Singh Chugh, Newcastle, WA (US)

(21) Appl. No.: 13/916,949

(22) Filed: Jun. 13, 2013

Related U.S. Application Data
(60) Provisional application No. 61/777,101, filed on Mar. 12, 2013.

(51) Int. Cl. G06Q 10/10

(52) U.S. Cl. CPC G06Q 10/1095
USPC 705/7.19

(57) ABSTRACT

Disclosed herein are systems, methods, and software for facilitating enhanced scheduling. In at least one implementation, a user may consider the availability of any room in a building when scheduling an event. Event entities including an event participant and an event environment having various sub-environments in which to host an event are identified. A participant availability for the event participant is identified based on a participant schedule associated with the event participant and an environment availability for the event environment is identified based on an environment schedule associated with each of the sub-environments. The participant availability for the event participant and the environment availability for the event environment are then presented for consideration by the user.

### RELATED APPLICATIONS

This application claims priority to U.S. Provisional Patent Application No. 61/777,101, entitled ENHANCED SCHEDULING and filed on Mar. 12, 2013, which is hereby incorporated by reference in its entirety.

### TECHNICAL FIELD

Aspects of the disclosure are related to computing hardware and software technology, and in particular to scheduling features in information management applications.

### TECHNICAL BACKGROUND

Information management applications provide users with effective and convenient ways to communicate with others and manage their information. Examples of information management applications include but are not limited to email applications and calendar applications. Some information management applications integrate these various types of applications by way of modules, such as email, calendar, contact, and task modules, although each type of application or functionality may also be provided in a stand-alone manner. Microsoft® Outlook® is one example of an information management application.

While many information management applications are provided as locally installed and executed applications, many can be experienced in a wide variety of ways. For example, some information management applications are available as web-based applications that are experienced through a browser application, as mobile applications customized for mobile environment, or even as a mobile web-based application generally developed for a mobile browser experience. In addition, information management applications can be experienced on a wide variety of computing devices, such as desktop, laptop, or tablet computers, mobile phones, gaming systems, Internet appliances, or any other physical or virtual computing system, variation, or combination thereof.

In many information management applications, calendar modules may be interacted with to schedule meetings and other events. A user may interact with a module to select people to invite to a meeting and possibly to select a room for the meeting.

Selecting a room for a meeting can be accomplished in much the same way as identifying convenient times for other participants. In the case of a participant, a user may examine the schedule for that participant in order to select a time for the meeting that coincides with the participant's availability. With respect to selecting a room, the user may examine the availability of the room in order to select a time that coincides with both their availability and that of the participant. In some scenarios, the availability of each of several rooms is examined before an available room can be identified.

However, before examining the availability for a room, the user must first identify which room to examine, such as by looking up a room just as one would to examine the availability of another participant. At times it is necessary for a user to search through and examine the availability of a number of rooms in a building before finding one that is open and can be reserved. This can be time consuming and may lead to a sub-optimal user experience, especially when the step of identifying the rooms is considered.

In at least one solution provided by Microsoft® Outlook®, the scheduling of a room is made somewhat easier by enabling a user to select a building in which to hold a meeting. A list of rooms in the building is then automatically presented to the user. At the very least this solution avoids the step of having to identify each individual room in a building. The user can then step through the availability of each room in order to arrive at one to include in a meeting. For example, several rooms may be presented. The user can select each room individually to see its availability, and if satisfactory, reserve the room.

### OVERVIEW

Provided herein are systems, methods, and software for facilitating enhanced scheduling. In at least one implementation, a user may consider the availability of any room in a building when scheduling an event. Event entities including an event participant and an event environment having various sub-environments in which to host an event are identified. A participant availability for the event participant is identified based on a participant schedule associated with the event participant and an environment availability for the event environment is identified based on an environment schedule associated with each of the sub-environments. The participant availability for the event participant and the environment availability for the event environment are then presented for consideration by the user.

This Overview is provided to introduce a selection of concepts in a simplified form that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an enhanced scheduling view in an implementation.

FIG. 2 illustrates an enhanced scheduling process in an implementation.

FIG. 3 illustrates a computing architecture in an implementation.

FIG. 4 illustrates a communication environment in an implementation.

FIG. 5 illustrates an operational scenario associated with a view of a calendar module in an implementation.

FIG. 6 illustrates an operational scenario associated with a view of a calendar module in an implementation.

FIG. 7 illustrates an operational scenario associated with a view of a calendar module in an implementation.

FIG. 8 illustrates an operational scenario associated with a view of a calendar module in an implementation.

### TECHNICAL DISCLOSURE

Implementations disclosed herein facilitate improved information management applications. In at least one implementation, a user may interact with an information management application, and in particular with a calendar module within the application, to schedule an event, such as a meeting. Various event entities may be identified to include in the event, such as an event participant and an event environment. The event environment may include sub-environments within which to potentially host the event. Availability for the event participant can be identified based on a schedule associated with the event participant. Availability for the event environment can be based on a schedule associated with each of the sub-environments. The availability for the event participant and the availability for the event environment may then be presented, enabling a user to schedule the event.

In some scenarios, the event environment may be a building and the sub-environments may be rooms. In addition, the event participant may be a person. Accordingly, an event may be scheduled based on both the availability of a person that may attend the event and the availability of any room, or at least either one of at least two rooms, within a building. In this manner, meetings may be scheduled in a more convenient manner that avoids the time consuming task of examining availability on a per-room basis.

In operation, an enhanced scheduling process may be implemented on a suitable computing system to provide enhanced scheduling within the context of an information management application. As all or portions of the information management applications are executed, interpreted, or otherwise processed, the computing system is driven to operate in accordance with the enhanced scheduling process to enable a user to consider the overall availability of a building when scheduling an event.

In accordance with the enhanced scheduling process, a computing system presents a view of an information management application. As a user interacts with the view to schedule an event, the computing system identifies event entities for the event including an event participant and an event environment. The event environment may include various sub-environments in which to potentially host the event.

Next, the computing system identifies a participant availability for the event participant based on a participant schedule associated with the event participant. In addition, the computing system identifies an environment availability for the event environment based on an environment schedule associated with each of the various sub-environments. The participant availability for the event participant and the environment availability for the event environment can then be presented to the user through the user interface.

In a brief operational example, a user interacts with a calendar module in an information management application to schedule a meeting with at least one other person in a specific building. The calendar perspective may include availability information for any event entities, such as the person and the building in this example, representative of the availability of the event entities. Accordingly, the availability for the person is identified and presented in the calendar perspective. In addition, the overall availability for the building is identified and presented in the calendar perspective. The overall availability for the building is determined based on the availability of various rooms in the building. For example, if none of the rooms are available during the time period scheduled for the event, then the building is represented in the calendar perspective as unavailable. On the other hand, if at least one room of the various rooms in the building is available, then the building is represented as available in the calendar perspective.

In some implementations, the view to the information management application includes a menu having various display options. The display options may include, for example, a building availability option and a room availability option. Selecting the building availability option in the menu results in the presentation of the availability information for the building. Selecting the room availability option results in the presentation of the availability information for at least one of the various rooms that are available.

The calendar perspective may include groups of cells in which to represent participant availability and environment availability. In an example, the cells may correspond to divisions of time throughout the day, such as hourly blocks, half-hour blocks and so on. The availability of a person for each individual block of time can be represented in a cell, as can the availability of a building. Thus, a user can easily compare when various participants are available with when any room in a specific building may be available.

Some of the implementations discussed herein make reference to various event entities, including an event participant and an event environment. It may be appreciated that the event entities may include at least an additional event participant. In other words, the various examples discussed herein make reference to an event participant merely for exemplary purposes while it may be understood that multiple event participants are possible.

Referring now to the drawings, FIG. 1 illustrates an enhanced view of an information management application with various features and functionality that may be experienced when an enhanced scheduling process, illustrated in FIG. 2, is carried out. FIG. 3 illustrates a computing architecture employed by any computing system suitable for implementing an enhanced scheduling process, and optionally all or portions of an information management application. FIG. 4 illustrates a communication environment in which an information management application and associated services are supported. FIGS. 5-7 illustrate various operational scenarios associated with an enhanced view of a calendar module in an information management application.

Turning to FIG. 1, an enhanced scheduling view 100 of an information management application is illustrated in an implementation. Enhanced scheduling view 100 of an information management application includes an information bar 101. Information bar 101 is optional, but may include information such as the name of the application or other information. In this example, enhanced scheduling view relates to a calendar module 103 included in the information management application. A daily perspective 105 is included in the enhanced scheduling view 100. Daily perspective 105 includes availability information for each of several participants identified for inclusion in an event. Their availability is provided on an hourly basis, such as their availability from 1:00 pm to 2:00 pm and so on. A filled-in area indicates that the participants are unavailable.

In addition to the participants, daily perspective 105 also includes the availability of any sub-environment in an environment identified for hosting the event. In this example, building 32 has no rooms available at 2:00 pm and 5:00 pm, but otherwise has at least one room available at other times. A user interacting with enhanced scheduling view 100 may therefor attempt to schedule an event for those times with high confidence that at least one room will be available. In some scenarios, a list of specific rooms that may be available can be presented, from which a specific room can be selected and included in an invite or other notification pertaining to the event.

FIG. 2 illustrates an enhanced scheduling process 200 for generating at least a portion of enhanced scheduling view 100. In operation, a user may interact with an information management application, and in particular with a calendar module within the application, to schedule an event, such as a meeting. Various event entities may be identified to include in the event (step 201), such as an event participant and an event environment. The event environment may include sub-environments within which to potentially host the event. Availability for the event participant can be identified based on a schedule associated with the event participant. Availability for the event environment can be based on a schedule associated with each of the sub-environments (step 203). The availability for the event participant and the availability for the event environment may then be presented, enabling a user to schedule the event (step 205).

Referring now to FIG. 3, computing architecture 300 is representative of an architecture that may be employed in any apparatus, system, or device, or collections thereof, to suitably implement all or portions of enhanced scheduling process 200 illustrated in FIG. 2 or variations thereof and optionally all or portions of the information management application referred to with respect to FIG. 1. Enhanced scheduling process 200 may be implemented on a single apparatus, system, or device or may be implemented in a distributed manner. The information management application may also be implemented on a single apparatus, system, or device or may be implemented in a distributed manner. Enhanced scheduling process 200 may be integrated with the information management application, but may also stand alone or be embodied in some other application.

Computing architecture 300 may be employed in, for example, desktop computers, laptop computers, tablet computers, notebook computers, mobile computing devices, cell phones, media devices, and gaming devices, as well as any other type of physical or virtual computing machine and any combination or variation thereof. Computing architecture 300 may also be employed in, for example, server computers, cloud computing platforms, data centers, any physical or virtual computing machine, and any variation or combination thereof.

Computing architecture 300 includes processing system 301, storage system 303, software 305, communication interface system 307, and user interface system 309. Processing system 301 is operatively coupled with storage system 303, communication interface system 307, and user interface system 309. Processing system 301 loads and executes software 305 from storage system 303. When executed by processing system 301, software 305 directs processing system 301 to operate as described herein for enhanced scheduling process 200 or its variations. Computing architecture 300 may optionally include additional devices, features, or functionality not discussed here for purposes of brevity.

Referring still to FIG. 3, processing system 301 may comprise a microprocessor and other circuitry that retrieves and executes software 305 from storage system 303. Processing system 301 may be implemented within a single processing device but may also be distributed across multiple processing devices or sub-systems that cooperate in executing program instructions. Examples of processing system 301 include general purpose central processing units, application specific processors, and logic devices, as well as any other type of processing device, combinations, or variation.

Storage system 303 may comprise any computer readable storage media readable by processing system 301 and capable of storing software 305. Storage system 303 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the storage media a propagated signal.

In addition to storage media, in some implementations storage system 303 may also include communication media over which software 305 may be communicated internally or externally. Storage system 303 may be implemented as a single storage device but may also be implemented across multiple storage devices or sub-systems co-located or distributed relative to each other. Storage system 303 may comprise additional elements, such as a controller, capable of communicating with processing system 301 or possibly other systems.

Software 305 may be implemented in program instructions and among other functions may, when executed by processing system 301, direct processing system 301 to operate as described herein for enhanced scheduling process 200 illustrated in FIG. 2. In one example implementation, the program instructions may direct processing system 301, or any suitable computing system in general, to initiate an availability request indicative of at least an event time and a plurality of event entities comprising an event participant and a building for an event. Responsive to an availability response comprising availability information for the event participant and the building, the program instructions may direct the processing system to initiate presentation of a calendar indicative at least whether any room is available in the building for the event.

In another example implementation, the program instructions may direct a computing system to identify event entities including an event participant and an event environment, identify a participant availability for the event participant based on a participant schedule associated with the event participant, identify an environment availability for the event environment based on an environment schedule associated with each of various sub-environments, and present the participant availability for the event participant and the environment availability for the event environment.

The program instructions may include various components or modules that cooperate or otherwise interact to carry out enhanced scheduling process 200. The various components or modules may be embodied in compiled or interpreted instructions or in some other variation or combination or instructions. The various components or modules may be executed in a synchronous or asynchronous manner, in a serial manner or in parallel, in a single threaded environment or multi-threaded, or in accordance with any other suitable execution paradigm, variation, or combination thereof. Software 305 may include additional processes, programs, or components, such as operating system software or other application software. Software 305 may also comprise firmware or some other form of machine-readable processing instructions executable by processing system 301.

In general, software 305 may, when loaded into processing system 301 and executed, transform a suitable apparatus, system, or device employing computing architecture 300 overall from a general-purpose computing system into a special-purpose computing system customized to facilitate enhanced scheduling views as described herein for each implementation. Indeed, encoding software 305 on storage system 303 may transform the physical structure of storage system 303. The specific transformation of the physical structure may depend on various factors in different implementations of this description. Examples of such factors may include, but are not limited to the technology used to implement the storage media of storage system 303 and whether the computer-storage media are characterized as primary or secondary storage, as well as other factors.

For example, if the computer-storage media are implemented as semiconductor-based memory, software 305 may transform the physical state of the semiconductor memory when the program is encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing architecture 300 is generally intended to represent an architecture on which software 305 may be deployed and executed in order to implement enhanced scheduling process 200 (or variations thereof) and optionally all or portions of an information management application. However, computing architecture 300 may also be suitable for any computing system on which software 305 may be staged and from where software 305 may be distributed, transported, downloaded, or otherwise provided to yet another computing system for deployment and execution, or yet additional distribution.

Communication interface system 307 may include communication connections and devices that allow for communication with other computing systems (not shown) over a communication network or collection of networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

User interface system 309 may include a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 309. In some cases, the input and output devices may be combined in a single device, such as a display capable of displaying images and receiving touch gestures. The aforementioned user input and output devices are well known in the art and need not be discussed at length here. User interface system 309 may also include associated user interface software executable by processing system 301 in support of the various user input and output devices discussed above. Separately or in conjunction with each other and other hardware and software elements, the user interface software and devices may support a graphical user interface, a natural user interface, or the like.

FIG. 4 illustrates a communication environment 400 in which various information management applications may be supported to implement enhanced scheduling views and their associated operations, such as enhanced scheduling view 100 discussed with respect to FIG. 1. Communication environment 400 includes application platform 401, application platform 403, and application platform 405. Application platform 401 and application platform 403 may communicate with service environment 407 to access information exchange service 417 on behalf of information management application 411 and information management application 413 respectively. Application platform 405 may communicate with service environment 409 to access information exchange service 419 on behalf of information management application 415. From time to time, service environment 407 and service environment 409 may communicate in furtherance of interaction between information exchange service 417 and information exchange service 419

Examples of application platforms 401, 403, and 405, include, but are not limited to, desktop computers, work stations, laptop computers, notebook computers, tablet computers, mobile phones, personal digital assistants, media devices, gaming devices, and any other physical or virtual computing machine or combinations and variations thereof capable of implementing at least one of a variety of information management applications. Service environment 407 may be any computing system or collection of computing systems capable of implementing an information exchange service 417.

Application platforms 401, 403, and 405 may each be any computing apparatus, system, device, or collections thereof that employ a computing architecture suitable for implementing information management application 411, 413, or 415 respectively. Computing architecture 300 referred to with respect to FIG. 3 is one such representative architecture. Information management applications 411, 413, and 415 may each be any version or variety of an information management application. Examples include but are not limited to locally installed and executed applications, streaming applications, web-based applications that execute at least in part within the context of a browser application, mobile applications, mobile web-based applications that execute at least in part within the context of a mobile browser application, or any other application type, variation, or combination thereof.

Information management applications 411, 413, and 415 may each be embodied in program instructions that, when executed by application platforms 401, 403, and 415 respectively, direct each to operate as described herein for enhanced scheduling process 200 discussed with respect to FIG. 2. The program instructions may take the form of compiled object code, interpreted scripts, or any other suitable form of program instructions that may be executed directly or indirectly by an application platform, as well as any suitable variation or combination thereof. Examples of information management applications include but are not limited to Microsoft® Outlook®, Mozilla Thunderbird/Lightening, Open Xchange, Microsoft® Outlook® Web App, Microsoft® Outlook® Web App for mobile devices, Outlook.com®, Gmail, and Microsoft® Outlook® for mobile devices, as well as any other suitable information management application, variation, or combination thereof.

Service environment 407 and service environment 409 may each include any computing apparatus, system, device, or collections thereof that employ a computing architecture suitable for implementing information exchange service 417 and information exchange service 419 respectively. Computing architecture 300 referred to with respect to FIG. 3 is one such representative architecture. Examples include server computers, cloud computing platforms, data centers, and any physical or virtual computing machine, as well as any variation or combination thereof. Examples of information exchange service 417 and information exchange service 419 include but are not limited to Microsoft® Exchange®, Microsoft® O365®, Hotmail®, Outlook.com®, and Gmail, as well as any other information exchange service, combination, or variation thereof capable of operating as described herein.

In operation, any of application platforms 401, 403, and 405 may communicate from time to time with service environment 407 or service environment 409 over communication network 410 to facilitate the exchange of information between information management applications 411 and 413 and information exchange service 417 and between information management application 415 and information exchange service 419. Service environment 407 and service environment 409 may also communicate over communication network 410 to facilitate the exchange of information.

Communication between any of the elements contemplated in FIG. 4 may occur in accordance with various communication protocols, such as the Internet protocol (IP, IPv4, IPv6, etc.), the transfer control protocol (TCP), and the user datagram protocol (UDP), as well as any other suitable communication protocol, variation, or combination thereof. Communication network 410 may be representative of a network or collection of networks over which the elements contemplated in FIG. 4 may exchange information, such as an intranet, the Internet, a local area network, a wide area network, a wireless network, a wired network, or any combination or variation thereof. Communication network 410 may include connections, devices, and communication media, such as metal, glass, air, or any other suitable communication media over which information may be exchanged. The aforementioned communication media, network, connections, protocols, and devices are well known and need not be discussed at length here.

The manner in which information is exchanged may vary. In some implementations, an application may exchange information with a service environment and information exchange service in accordance with various information exchange protocols, such as IMAP (internet message access protocol), POP (post office protocol), SMTP (simple mail transfer protocol), and MAPI (message application programming interface). In other implementations, an application may exchange information with a service environment and information exchange service in accordance with various other information exchange protocols, such as HTTP (hypertext transfer protocol), REST (representational state transfer), or WebSocket, as well as any other suitable information exchange protocol, variation, or combination thereof.

What information is exchanged or what format the information takes may also vary. For example, an application or associated browser (in the case of a browser based application) may receive information formatted in accordance with a variety of information protocols, such as DOM (Document Object Model), HTML (hypertext markup language), CSS (cascading style sheets), HTML5, XML (extensible markup language), Javascript, JSON (Javascript Object Notation), and AJAX (Asynchronous Javascript and XML), as well as any other suitable information protocol, variation, or combination thereof. The information may include data or objects that may be processed for presentation, such as images and text. However, the information may also include scripts or other information that may be interpreted or otherwise processed by the browser or some other application for execution. In other implementations, an application may exchange discrete messages representative of an email, calendar event, or some other item of information formatted in accordance with an information protocol suitable to that application.

FIGS. 5-8 illustrate various operational scenarios associated with an enhanced view of a calendar module in an information management application. The operational scenarios demonstrate various features and functionality that may be experienced when a user interacts with an information management application. The enhanced view discussed with respect to FIGS. 5-8 may be presented by a suitable computing platform executing all or portions of the information management application, examples of which include application platforms 401, 403, and 405. Examples of the information management application include information management applications 411, 413, and 415.

Referring now to FIG. 5, enhanced view 500 includes an information bar 501, a scheduling panel 503, and a calendar perspective 505. In this scenario, the calendar perspective 505 is presented in a “week view” in that various days of the week are presented. It may be appreciated that enhanced view 500 may include other elements in addition to or in place of those disclosed herein, or even fewer elements than those disclosed herein. Scheduling panel 503 is any graphical element or collection of elements through which a user may input or edit event information for an event. Calendar perspective 505 is any graphical element or collection of elements through which availability information may be presented.

Scheduling panel 503 includes a details module 507 and an attendees module 509. It may be appreciated that scheduling panel 503 and attendees module could include other elements in addition to or in place of those disclosed herein, or even fewer elements. Details module 507 is any graphical element or collection of elements through which the details of an event may be input or edited. Attendees module 509 is any graphical element or collection of elements through which the attendees of an event may be input or edited. Attendees module 509 include a scheduling feature 519, but may also include other elements, such as contacts associated with people invited to or being considered for an event.

Calendar perspective 505 is any graphical element or collection of elements through which a block of time may be subdivided and presented as a calendar. Calendar perspective 505 may be scaled in a variety of modes, such as in a week mode, a month mode, or a day mode. The cells into which calendar perspective 505 is divided, of which cell 521 is representative, scale based on the selected mode. For example, when in a month mode each cell typically represents a day in a week, when in a week mode each cell typically represents a block of time in a day, and when in a day mode each cell typically represents a block of time in a day. It may be appreciated that the cells may correspond to other units of time and are not limited to just those disclosed herein. In this implementation, the cells in calendar perspective 505 are defined by rows and columns, of which rows 523, 525 and columns 527, 529 are representative.

Referring still to FIG. 5, in operation a user has selected or otherwise input via date module 511 the date of Friday, March 22 for a meeting. The time of the meeting has been set for 1:00 pm to 2:00 pm through time module 513. In addition, contact 515 and contact 517 corresponding to two participants, Alton and Sangya respectively, have been added to an attendees list. Contact 515 and contact 517 include various types of contact information for people, such as their names, phone numbers, email address, and possibly images 516 and 518 of the people.

In response, calendar perspective 505 is populated with availability information associated with the proposed meeting. In particular, calendar perspective 505 includes availability information representative of at least the state of any scheduling conflict between the participants in the attendee list and the availability of a building identified for the meeting. Legend 531 illustrates two color schemes used to convey in each cell the state of the conflicts and building availability. Cells colored in a grey fill represent that no rooms are available in the identified building at the time, while cells having a partial black fill indicate that a scheduling conflict exists between the participants.

As an example, the cell corresponding to Monday at 9:00 AM is blank indicating that no conflict exists and that at least one room is available in the building. However, at 10:00 AM on Monday, both a scheduling conflict exists and no rooms are available in the building. Finally, at 11:00 AM on Monday, no scheduling conflict exists, but no rooms are available in the building.

A user interacting with enhanced view 500 can survey the availability information presented in calendar perspective 505 in order to arrive at an optimal time and day for the meeting. Note how on Friday at 1:00 PM, the suggested date and time for the meeting, there is no availability in the building and conflicts exist. Thus, a new date or time (or both) may be identified so that the meeting can occur in the building.

Referring now to FIG. 6, to assist with finding an improved date and time, a user may select scheduling feature 519 such as by clicking on, touching, or hovering over scheduling feature 519. Any such indication of interest is represented by touch 533. Scheduling feature 519 may be any graphical element that, when selected, results in the rendering of a menu 508. Menu 508 includes various options for viewing availability information in calendar perspective 505, which is presented in day mode in FIG. 6.

The options in menu 508 include a “show all rooms” option, a ‘show the availability for any room” option, and a “select a new building” option. In addition, menu 508 includes the state of availability for the building identified for the meeting. The building may be specified by the scheduler or may be auto-selected by the application based on a variety of criteria, such as the buildings in which the participants work, the most recent building used, or some other factor or criteria.

In this operational scenario, it is assumed that a user selects the “show the availability for any room” option, in response to which the availability for building number 32 is presented in a column alongside the availability for Alton and Sangya, which is illustrated in FIG. 7. Referring now to FIG. 7, the column associated with building number 32, as well as those for Alton and Sangya, includes various cells shaded according to their availability. A shaded cell indicates, per legend 531, that the building has no available rooms for the block of time corresponding to each cell. Similarly, the cells associated with Alton and Sangya also include shading in those cells corresponding to blocks of time during which each participant is unavailable.

It may be appreciated from calendar perspective 505 that Alton and Sangya have overlapping availability at 10:00 AM, 1:00 PM, and 3:00 PM. However, building number 32 is mostly fully occupied, with the exception of blocks of time at 10:00 AM and 5:00 PM. A user viewing calendar perspective 505 may realize that the only block of time in which Alton and Sangya are available, and in which building number 32 has at least some availability, is the block of time from 10:00 AM to 11:00 AM.

Continuing with this operational scenario in FIG. 8, a user may change the proposed time for the meeting in view of the various scheduling conflicts and building availability presented through calendar perspective 505. In FIG. 8, the meeting time is changed to 10:00 AM. It may be appreciated that the availability status of building number 32 in menu 508 is changed to indicate that, indeed, at least one room is available during that time.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. One or more computer readable storage media having program instructions stored thereon for facilitating event scheduling that, when executed by a computing system, direct the computing system to at least:
identify a plurality of event entities comprising an event participant and an event environment, the event environment comprising a plurality of sub-environments in which to potentially host an event;
identify a participant availability for the event participant based on a participant schedule associated with the event participant;
identify an environment availability for the event environment based on an environment schedule associated with each of the plurality of sub-environments; and
present the participant availability for the event participant and the environment availability for the event environment.

2. The one or more computer readable storage media of claim 1 wherein the event participant comprises a person, wherein the event environment comprises a building and wherein the plurality of sub-environments comprises a plurality of rooms in the building.

3. The one or more computer readable storage media of claim 2 wherein to identify the environment availability for the event environment based on the environment schedule associated with each of the plurality of sub-environments, the program instructions direct the computing system to determine an overall availability for the building based on whether or not any of the plurality of rooms are available, wherein the environment availability comprises the overall availability of the building.

4. The one or more computer readable media of claim 3 wherein the program instructions direct the computing system to present a calendar perspective comprising availability information for each of the plurality of event entities, wherein the availability information for the event environment indicates the overall availability of the building.

5. The one or more computer readable storage media of claim 4 wherein the program instructions further direct the computing system to present a menu comprising a plurality of display options comprising building availability option and a room availability option.

6. The one or more computer readable storage media of claim 5 wherein, responsive to selecting the building availability option in the menu, the program instructions direct the computing system to present the availability information for the building and wherein, responsive to selecting the room availability option, the program instructions direct the computing system to display the availability information for at least one of any of the plurality of rooms that are available.

7. The one or more computer readable media of claim 5 wherein, to present the participant availability for the event participant, the program instructions direct the computing system to represent the participant availability in a first plurality of cells in the calendar perspective associated with the event participant.

8. The one or more computer readable media of claim 6 wherein, to present the environment availability for the event environment, the program instructions direct the computing system to represent the environment availability in a second plurality of cells in the calendar perspective associated with the event environment.

9. The one or more computer readable storage media of claim 1 wherein the plurality of event entities further comprises an additional event participant and wherein the program instructions further direct the computing system to identify additional availability for the additional event participant based on an additional schedule associated with the additional event participant and present the additional availability.

10. A method for facilitating event scheduling comprising:
identifying a plurality of event entities comprising an event participant and an event environment, the event environment comprising a plurality of sub-environments in which to potentially host an event;
identifying a participant availability for the event participant based on a participant schedule associated with the event participant;
identifying an environment availability for the event environment based on an environment schedule associated with each of the plurality of sub-environments; and
presenting the participant availability for the event participant and the environment availability for the event environment.

11. The method of claim 10 wherein the event participant comprises a person, wherein the event environment comprises a building and wherein the plurality of sub-environments comprises a plurality of rooms in the building.

12. The method of claim 11 wherein identifying the environment availability for the event environment based on the environment schedule associated with each of the plurality of sub-environments comprises determining an overall availability for the building based on whether or not any of the plurality of rooms are available, wherein the environment availability comprises the overall availability of the building.

13. The method of claim 12 further comprising presenting a calendar perspective comprising availability information for each of the plurality of event entities that indicates the overall availability of the building.

14. The method of claim 13 further comprising presenting a menu having at least an availability option and a room availability option.

15. The method of claim 14 further comprising, responsive to selecting the building availability option in the menu, presenting the availability information for the building and wherein, responsive to selecting the room availability option, displaying the availability information for at least one of any of the plurality of rooms that are available.

16. The method of claim 14 wherein presenting the participant availability for the event participant comprises representing the participant availability in a first plurality of cells in the calendar perspective associated with the event participant.

17. The method of claim 15 wherein presenting the environment availability for the event environment comprises representing the environment availability in a second plurality of cells in the calendar perspective associated with the event environment.

18. The method of claim 10 wherein the plurality of event entities further comprises an additional event participant and wherein the method further comprises identifying additional availability for the additional event participant based on an additional schedule associated with the additional event participant and presenting the additional availability.

19. A computing apparatus comprising:
one or more computer readable storage media;
program instructions stored on the one or more computer readable storage media thereon for facilitating event scheduling that, when executed by a processing system, direct the computing system to at least:
initiate an availability request indicative of at least an event time and a plurality of event entities comprising an event participant and a building for an event;
responsive to an availability response comprising availability information for the event participant and the building, initiate presentation of a calendar indicative at least whether any room is available in the building for the event.

20. The computing apparatus of claim 19 further comprising the processing system configured to process the program instructions and a display system to present the calendar, wherein the program instructions further direct the processing system to initiate presentation of a menu comprising an availability option for viewing an overall availability of the building and a room availability option for viewing an availability of at least one of any room in the building having availability for the event.
